(19) United States
(12) Patent Application Publication
(10) Pub. No.: US 2019/0329388 A1
(43) Pub. Date: Oct. 31, 2019

(54) FASTENER RETENTION MECHANISMS

(71) Applicant: IMDS LLC, Providence, UT (US)

(72) Inventors: Nathan W. Erickson, Beaver Dam, UT (US); Justin Hyer, Hyrum, UT (US)

(21) Appl. No.: 16/394,244

(22) Filed: Apr. 25, 2019

Related U.S. Application Data
(60) Provisional application No. 62/663,826, filed on Apr. 27, 2018.

(51) Int. Cl. B25B 23/08

(52) U.S. Cl. CPC B25B 23/08

(57) ABSTRACT

Fasteners and instruments with fastener retention mechanisms are disclosed. The fastener retention mechanisms may be independent of fastener deployment forces, such as torque. The fastener retention mechanisms may include spring elements of the instruments, whose flexion is limited by other features of the instruments so that the springs function only in their elastic zones and are prevented from experiencing yielding, plastic deformation, bending, cracking, or breaking.

### CROSS-REFERENCE TO RELATED APPLICATIONS

The present application claims the benefit of

U.S. Provisional Application Ser. No. 62/663,826, filed Apr. 27, 2018, entitled FASTENER RETENTION MECHANISMS, Attorney's Docket No. IMDS-62 PROV.

The foregoing is incorporated by reference as though set forth herein in its entirety.

### TECHNICAL FIELD

The present disclosure relates to mechanisms to retain a fastener or other small part to a driver or other tool, while permitting easy attachment of the part to the tool, and permitting the part to be disconnected from the tool. More specifically, the present disclosure is made in the context of threaded fasteners, such as screws or nuts, and corresponding drivers.

### BACKGROUND

It is advantageous to temporarily retain a fastener or other small part to a driver or other tool for many reasons, such as avoiding dropping the fastener, access to tight working spaces, ease of use without direct visualization, secure connection of torque fittings, and the like. This is particularly the case in the field of medical devices.

### SUMMARY

The various systems and methods of the present technology have been developed in response to the present state of the art, and in particular, in response to the problems and needs in the art that have not yet been fully solved by currently available fastener retention mechanisms.

To achieve the foregoing, and in accordance with the technology as embodied and broadly described herein, in an aspect of the technology, a system includes: a fastener including a head including a fastener torque fitting; and a tool including a tool torque fitting and a spring, wherein the tool torque fitting engages the fastener torque fitting to transmit torque between the tool and the fastener; wherein when the tool torque fitting is engaged with the fastener torque fitting, the spring presses upon the fastener head to retain the fastener to the tool; wherein the tool limits flexion of the spring so that the spring functions only in its elastic zone.

Embodiments of this aspect of the technology may include one or more of the following characteristics. The spring includes a free state and a fully flexed state; wherein the spring is in the free state when the tool is disengaged from the fastener; wherein when the spring is in the fully flexed state, a tool-contacting portion of the spring contacts a spring-contacting portion of the tool to limit further flexion of the spring, and the spring is in its elastic zone. The spring moves from the free state toward the fully flexed state as the tool torque fitting engages the fastener torque fitting. The tool includes a tool axis; wherein the tool torque fitting engages the fastener torque fitting to transmit torque between the tool and the fastener about the tool axis; wherein when the spring is in the free state, a fastener-contacting portion of the spring is a first distance from the tool axis; wherein when the spring is in the fully flexed state, the fastener-contacting portion of the spring is a second distance from the tool axis, wherein the second distance is different from the first distance. The tool includes a shaft that includes the tool torque fitting; wherein the spring is a tube including a central longitudinal through hole; wherein the shaft extends through the through hole; wherein the tool-contacting portion of the spring is an inner surface of the through hole; wherein the spring-contacting portion of the tool is an outer surface of the shaft. The spring includes an opening through one side wall of the tube between the through hole and an exterior surface of the tube. The fastener-contacting portion of the spring is a tooth that protrudes from the inner surface of the through hole; wherein the fastener head includes a circumferential groove; wherein when the tool torque fitting is engaged with the fastener torque fitting, the tooth is received in the groove to retain the fastener to the tool.

In another aspect of the technology, a system includes: a fastener including a head including a fastener coupling; and a tool including a tool coupling and a spring, wherein the tool coupling engages the fastener coupling to actuate the fastener; wherein when the tool coupling is engaged with the fastener coupling, the spring presses upon the fastener head to retain the fastener to the tool; wherein the tool limits flexion of the spring so that the spring functions only in its elastic zone.

Embodiments of this aspect of the technology may include one or more of the following characteristics. The spring includes a free state and a fully flexed state; wherein the spring is in the free state when the tool is disengaged from the fastener; wherein when the spring is in the fully flexed state, a tool-contacting portion of the spring contacts a spring-contacting portion of the tool to limit further flexion of the spring, and the spring is in its elastic zone. The spring moves from the free state toward the fully flexed state as the tool coupling engages the fastener coupling. The tool includes a central longitudinal tool axis; wherein when the spring is in the free state, a fastener-contacting portion of the spring is a first distance from the tool axis; wherein when the spring is in the fully flexed state, the fastener-contacting portion of the spring is a second distance from the tool axis, wherein the second distance is different from the first distance. The tool includes a shaft that includes the tool coupling; wherein the spring is a tube including a central longitudinal through hole; wherein the shaft extends through the through hole; wherein the tool-contacting portion of the spring is an inner surface of the through hole; wherein the spring-contacting portion of the tool is an outer surface of the shaft. The spring includes an opening through one side wall of the tube between the through hole and an exterior surface of the tube. The fastener-contacting portion of the spring is a tooth that protrudes from the inner surface of the through hole; wherein the fastener head includes a circumferential groove; wherein when the tool coupling is engaged with the fastener coupling, the tooth is received in the groove to retain the fastener to the tool.

In yet another aspect of the technology, a system includes: a fastener including a head including a fastener coupling; and a tool including a tool coupling and a sleeve around the tool coupling, wherein the tool coupling engages the fastener coupling to actuate the fastener; wherein when the tool coupling is engaged with the fastener coupling, the sleeve presses upon the fastener head to retain the fastener to the tool; wherein the tool limits flexion of the sleeve so that the sleeve is prevented from experiencing yielding, plastic deformation, or bending.

Embodiments of this aspect of the technology may include one or more of the following characteristics. The sleeve includes a free state and a fully flexed state; wherein the sleeve is in the free state when the tool is disengaged from the fastener; wherein when the sleeve is in the fully flexed state, a tool-contacting portion of the sleeve contacts a sleeve-contacting portion of the tool to limit further flexion of the sleeve to prevent the sleeve from experiencing yielding, plastic deformation, or bending. The sleeve moves from the free state toward the fully flexed state as the tool coupling engages the fastener coupling. The tool includes a central longitudinal tool axis; wherein when the sleeve is in the free state, a fastener-contacting portion of the sleeve is a first distance from the tool axis; wherein when the sleeve is in the fully flexed state, the fastener-contacting portion of the sleeve is a second distance from the tool axis, wherein the second distance is different from the first distance. The tool includes a shaft that includes the tool coupling; wherein the sleeve is a tube including a central longitudinal through hole; wherein the shaft extends through the through hole; wherein the tool-contacting portion of the sleeve is an inner surface of the through hole; wherein the sleeve-contacting portion of the tool is an outer surface of the shaft. The fastener-contacting portion of the sleeve is a tooth that protrudes from the inner surface of the through hole; wherein the fastener head includes a circumferential groove; wherein when the tool coupling is engaged with the fastener coupling, the tooth is received in the groove to retain the fastener to the tool.

These and other features and advantages of the present technology will become more fully apparent from the following description and appended claims, or may be learned by the practice of the technology as set forth hereinafter.

### BRIEF DESCRIPTION OF THE DRAWINGS

Exemplary embodiments of the technology will become more fully apparent from the following description and appended claims, taken in conjunction with the accompanying drawings. Understanding that these drawings depict only exemplary embodiments and are, therefore, not to be considered limiting of the scope of the technology, the exemplary embodiments will be described with additional specificity and detail through use of the accompanying drawings in which:

FIG. 1 is an oblique view of an instrument with a fastener retention mechanism;

FIG. 2 is another oblique view of the instrument of FIG. 1 from a different direction;

FIG. 3 is a front view of the instrument of FIG. 1, a cap nut shown disconnected from the instrument;

FIG. 4 is a right view of the instrument of FIG. 1, the cap nut disconnected from the instrument;

FIG. 5 is an oblique exploded view of the instrument of FIG. 1;

FIG. 6 is another oblique exploded view of the instrument of FIG. 1 from a different direction;

FIG. 7 is a cross-sectional detail view of a portion of the instrument of FIG. 3 taken along section line 7-7 of FIG. 3, a spring of the instrument in a free or relaxed state;

FIG. 8 is a cross-sectional detail view of a portion of the instrument of FIG. 4 taken along section line 8-8 of FIG. 4, at the same scale as FIG. 7;

FIG. 9 is a cross-sectional detail view of a portion of the instrument of FIG. 1 taken along section line 7-7 of FIG. 3, the cap nut connected to the instrument, the spring in a fully flexed state;

FIG. 10 is a cross-sectional detail view of a portion of the instrument of FIG. 1 taken along section line 7-7 of FIG. 3, the cap nut connected to the instrument, the spring in a partially flexed state engaging the cap nut, at the same scale as FIG. 9;

FIG. 11 is an oblique view of another instrument with another fastener retention mechanism;

FIG. 12 is another oblique view of the instrument of FIG. 11 from a different direction;

FIG. 13 is an oblique exploded view of the instrument of FIG. 11;

FIG. 14 is another oblique exploded view of the instrument of FIG. 11 from a different direction;

FIG. 15 is an oblique view of a sleeve of the instrument of FIG. 11;

FIG. 16 is another oblique view of the sleeve of FIG. 15 from a different direction;

FIG. 17 is an oblique view of a spring of the instrument of FIG. 11;

FIG. 18 is another oblique view of the spring of FIG. 17 from a different direction;

FIG. 19 is a front view of the instrument of FIG. 11 coupled to a fastener;

FIG. 20 is a cross-sectional detail view of a portion of the instrument and fastener of FIG. 19 taken along section line 20-20 of FIG. 19;

FIG. 21 is an oblique view of another instrument with another fastener retention mechanism;

FIG. 22 is another oblique view of the instrument of FIG. 21 from a different direction;

FIG. 23 is a front view of the instrument of FIG. 21 coupled to a fastener;

FIG. 24 is an oblique exploded view of the instrument of FIG. 21;

FIG. 25 is another oblique exploded view of the instrument of FIG. 21 from a different direction;

FIG. 26 is a cross-sectional detail view of a portion of the instrument and fastener of FIG. 23 taken along section line 26-26 of FIG. 23, a screw holder of the instrument in a fully flexed state;

FIG. 27 is a cross-sectional detail view of a portion of the instrument and fastener of FIG. 23 taken along section line 26-26 of FIG. 23, the screw holder in a partially flexed state, at the same scale as FIG. 26;

FIG. 28 is an oblique view of another instrument with another fastener retention mechanism;

FIG. 29 is another oblique view of the instrument of FIG. 28 from a different direction;

FIG. 30 is an oblique exploded view of the instrument of FIG. 28;

FIG. 31 is another oblique exploded view of the instrument of FIG. 28 from a different direction;

FIG. 32A is a left view of a tip part of the instrument of FIG. 30; FIG. 32B is a front view of the tip part of FIG. 32A, at the same scale as FIG. 32A; FIG. 32C is a right view of the tip part of FIG. 32A, at the same scale as FIG. 32A; and FIG. 32D is a bottom view of the tip part of FIG. 32A, at the same scale as FIG. 32A;

FIG. 33 is a top view of the instrument of FIG. 28;

FIG. 34 is a cross-sectional view of the instrument of FIG. 28 taken along section line 34-34 of FIG. 33;

FIG. 35 is a side view of the instrument of FIG. 28 with a fastener in a first coupled state;

FIG. 36 is a cross-sectional detail view of a portion of the instrument and fastener of FIG. 35 taken along section line 36-36 of FIG. 35, the instrument and fastener in the first coupled state;

FIG. 37 is a cross-sectional detail view of a portion of the instrument and fastener of FIG. 35 taken along section line 36-36 of FIG. 35, the instrument and fastener in a second coupled state, at the same scale as FIG. 36;

FIG. 38 is another side view of the instrument of FIG. 28 with the fastener of FIG. 35 in the first coupled state;

FIG. 39 is a cross-sectional detail view of a portion of the instrument and fastener of FIG. 38 taken along section line 39-39 of FIG. 38, the instrument and fastener in the first coupled state; and

FIG. 40 is a cross-sectional detail view of a portion of the instrument and fastener of FIG. 38 taken along section line 39-39 of FIG. 38, the instrument and fastener in the second coupled state, at the same scale as FIG. 39.

### DETAILED DESCRIPTION

Exemplary embodiments of the technology will be best understood by reference to the drawings, wherein like parts are designated by like numerals throughout. It will be readily understood that the components of the technology, as generally described and illustrated in the figures herein, could be arranged and designed in a wide variety of different configurations. Thus, the following more detailed description of the embodiments of the apparatus, system, and method is not intended to limit the scope of the invention, as claimed, but is merely representative of exemplary embodiments of the technology.

The phrases “connected to,” “coupled to” and “in communication with” refer to any form of interaction between two or more entities, including mechanical, electrical, magnetic, electromagnetic, fluid, and thermal interaction. Two components may be functionally coupled to each other even though they are not in direct contact with each other. The term “abutting” refers to items that are in direct physical contact with each other, although the items may not necessarily be attached together. The phrase “fluid communication” refers to two features that are connected such that a fluid within one feature is able to pass into the other feature.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Standard medical planes of reference and descriptive terminology are employed in this specification. While these terms are commonly used to refer to the human body, certain terms are applicable to physical objects in general.

A standard system of three mutually perpendicular reference planes is employed. A sagittal plane divides a body into right and left portions. A coronal plane divides a body into anterior and posterior portions. A transverse plane divides a body into superior and inferior portions. A mid-sagittal, mid-coronal, or mid-transverse plane divides a body into equal portions, which may be bilaterally symmetric. The intersection of the sagittal and coronal planes defines a superior-inferior or cephalad-caudal axis. The intersection of the sagittal and transverse planes defines an anterior-posterior axis. The intersection of the coronal and transverse planes defines a medial-lateral axis. The superior-inferior or cephalad-caudal axis, the anterior-posterior axis, and the medial-lateral axis are mutually perpendicular.

Anterior means toward the front of a body. Posterior means toward the back of a body. Superior or cephalad means toward the head. Inferior or caudal means toward the feet or tail. Medial means toward the midline of a body, particularly toward a plane of bilateral symmetry of the body. Lateral means away from the midline of a body or away from a plane of bilateral symmetry of the body. Axial means toward a central axis of a body. Abaxial means away from a central axis of a body. Ipsilateral means on the same side of the body. Contralateral means on the opposite side of the body. Proximal means toward the trunk of the body. Proximal may also mean toward a user or operator. Distal means away from the trunk. Distal may also mean away from a user or operator. Dorsal means toward the top of the foot. Plantar means toward the sole of the foot. Varus means deviation of the distal part of the leg below the knee inward, resulting in a bowlegged appearance. Valgus means deviation of the distal part of the leg below the knee outward, resulting in a knock-kneed appearance.

In this specification, standard medical anatomical terms are employed with their ordinary and customary meanings.

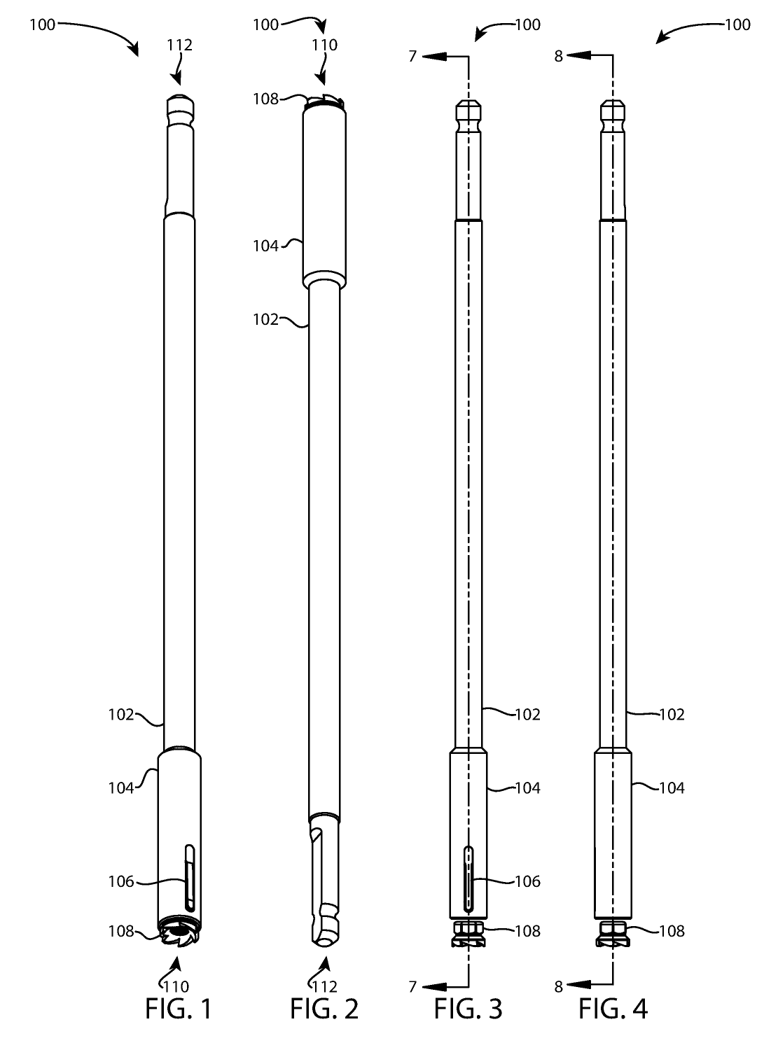

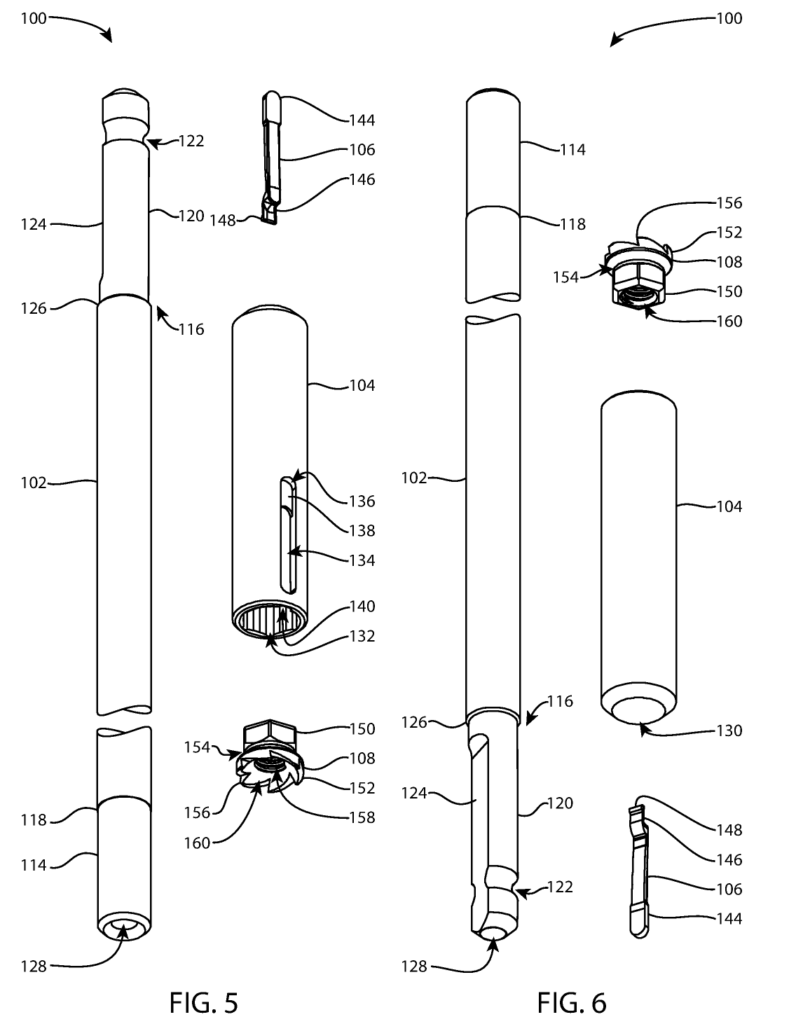

Referring to FIGS. 1-10, an instrument 100 may be an assembly that includes a shaft 102, a sleeve 104, and a spring 106. The instrument may couple to a cap nut 108 or other fastener, such as a screw. The instrument 100, its component parts 102, 104, 106, and the cap nut 108 may each extend between a distal end 110, or working end, and a proximal end 112 toward a user.

The shaft 102 may be an elongated generally cylindrical part that may include a distal diameter portion 114 at the distal end 110 and a torque fitting 116 at the proximal end 112. The distal diameter portion 114 couples to the sleeve 104. The distal diameter portion 114 may have a smaller outer diameter than the main portion of the shaft 102, as shown, a larger diameter, or the same nominal diameter and a different tolerancing scheme than the main portion of the shaft 102. A boundary 118 may exist between the distal diameter portion 114 and the main portion of the shaft 102. The boundary 118 may be a shoulder formed due to a step change in diameter. The torque fitting 116 couples to a torque source such as an electric or pneumatic drill/driver or a manual T-handle to transmit torque to the shaft 102. The torque fitting 116 may couple to the handle 202 described below for instrument 200. The illustrated torque fitting 116 includes a proximal diameter portion 120, a groove 122, and a flat 124. The proximal diameter portion 120 may have a smaller outer diameter than the main portion of the shaft 102, as shown, a larger diameter, or the same nominal diameter and a different tolerancing scheme than the main portion of the shaft 102. A boundary 126 may exist between the proximal diameter portion 120 and the main portion of the shaft 102. The boundary 126 may be a shoulder formed due to a step change in diameter. The boundary 126 may be at the distal-most end of the torque fitting 116. The groove 122 may extend circumferentially around the proximal diameter portion 120 near the proximal end 112. The flat 124 may be unilateral and may extend longitudinally from the proximal end 112 to a location between the groove 122 and the boundary 126. A central longitudinal hole 128 may extend through the shaft 102 between the distal and proximal ends 110, 112. The hole 128 may have a uniform inner diameter.

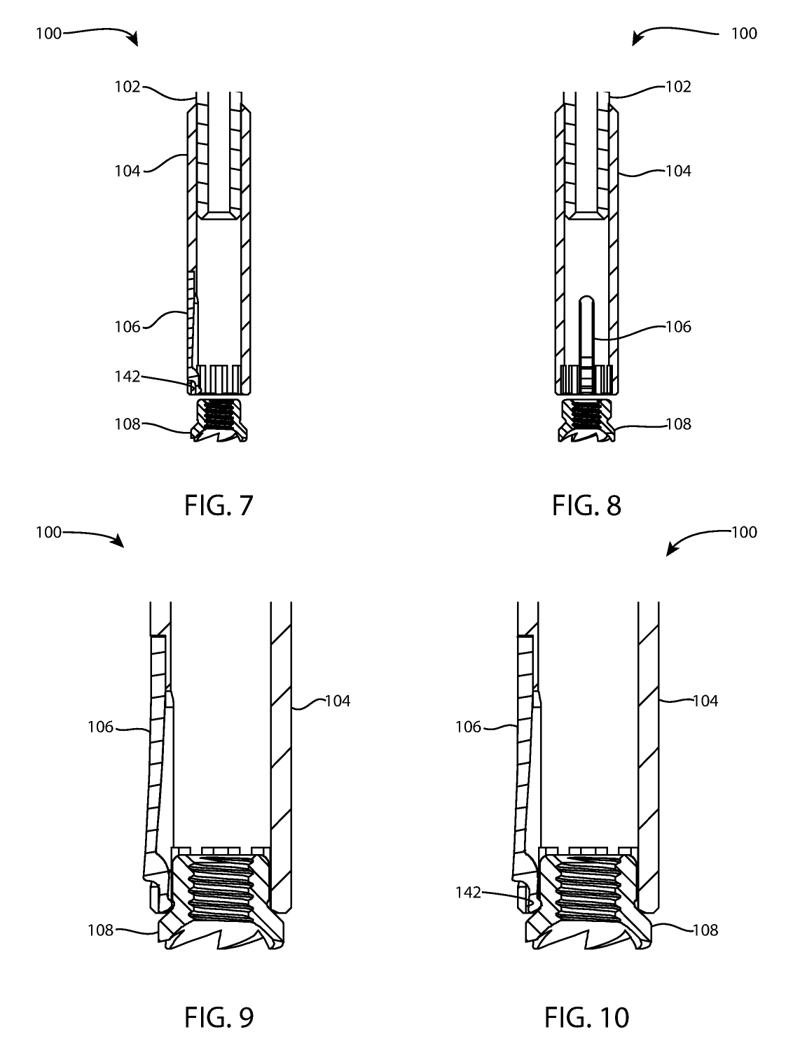

The sleeve 104 may be an elongated generally cylindrical part. A central longitudinal hole 130 may extend through the sleeve 104 between the distal and proximal ends 110, 112. The hole 130 may have a uniform inner diameter. The proximal end of the hole 130 may receive the distal diameter portion 114 of the shaft 102. The shaft 102 and sleeve 104 may be permanently fixed together, for example by welding. A torque fitting 132 may be included at the distal end 110. The illustrated torque fitting 132 is a hex socket that extends into the sleeve 104 from the distal end 110. A window 134 may extend through one side of the sleeve 104 to intersect the hole 130 and/or the torque fitting 132. The illustrated window 134 intersects a distal portion of the hole 130 and a proximal portion of the torque fitting 132. The window 134 may be longitudinally elongated such as the oval shown. A slot 136 may extend into an outer surface of the sleeve 104 adjacent to the proximal end of the window 134, and may extend longitudinally proximally from the window. The slot 136 may be a longitudinal extension of the window 134. The slot 136 may extend into the wall of the sleeve 104 to form a shelf 138. A longitudinal groove 140 may extend into an inner surface of the sleeve 104 adjacent to the distal end of the window 134, and may extend longitudinally distally from the window through the distal end 110. The longitudinal groove 140 may be a longitudinal extension of the window 134. The longitudinal groove 140 may extend partially through the wall of the sleeve 104 to form a shelf 142 (FIGS. 7 and 10).

The spring 106 may be a thin narrow part that is elongated between the distal and proximal ends 110, 112. The spring 106 may have a generally rectangular cross-sectional shape. The spring 106 may include a proximal tab 144 and a distal jaw 146. The tab 144 may be wider than the main portion of the spring 106. The tab 144 may be received in the slot 136 of the sleeve 104 so that an inner surface of the tab 144 directly contacts the shelf 138. The tab 144 may be permanently fixed in the slot 136, for example by welding. The jaw 146 may be inwardly offset from the main portion of the spring 106. When the tab 144 is received in the slot 136, the jaw 146 may be received in the longitudinal groove 140 so that an outer surface of the jaw 146 may face an inner surface of the shelf 142. The shelf 142 may limit outward flexion of the spring 106 so that the spring remains in the elastic zone and is prevented from experiencing yielding, plastic deformation, bending, cracking, or breaking. A tooth 148 may protrude from an inner surface of the jaw 146, and may extend transversely across the inner surface of the jaw 146 as shown.

The cap nut 108 includes a proximal torque fitting 150, a distal body 152, and a groove 154. The torque fitting 150 may be a hex key, as shown. The torque fitting 150 may couple to the torque fitting 132 of the sleeve 104 to transmit torque to the cap nut 108. The body 152 may have an outer diameter that is larger than the torque fitting 150. The body 152 may include a circular array of distally-facing sawtooth features 156. The groove 154 may extend circumferentially around the cap nut 108 between the torque fitting 150 and the body 152. The minor diameter of the groove 154 may be less than the torque fitting 150. The groove 154 may receive the tooth 148 of the spring 106. While a full circumferential groove is shown, a single pocket would suffice to receive the tooth 148. A central longitudinal hole 158 may extend through the sleeve 104 between the distal and proximal ends 110, 112. The hole 158 may be internally threaded as shown. A recess 160 may extend into the body 152 from the proximal end 112. The recess 160 may be spherical.

When the instrument 100 is operatively assembled, the distal diameter portion 114 of the shaft 102 may be received in the proximal end of the hole 130 of the sleeve 104. The boundary 118 may abut the proximal edge of the hole 130. The shaft 102 and the sleeve 104 may be permanently fixed together. The proximal tab 144 of the spring 106 may be received in the slot 136 sleeve 104 so that an inner surface of the tab 144 directly contacts the shelf 138. The jaw 146 of the spring 106 may be received in the longitudinal groove 140 so that an outer surface of the jaw 146 may face an inner surface of the shelf 142, and so that the tooth 148 faces into the hole 130 and/or torque fitting 132. The spring 106 and the sleeve 104 may be permanently fixed together, for example by welding around the outer perimeter of the tab 144/inner perimeter of the slot 136.

Referring to FIGS. 7 and 8, when the instrument 100 is operatively assembled, the spring 106 has a free state when the torque fitting 132 of the sleeve 104 and the torque fitting 150 of the cap nut 108 are disconnected. In the free state, the inner tip of the tooth 148 is at its innermost position closest to the central longitudinal axis of the sleeve 104 (which is collinear with section lines 7-7 of FIG. 3 and 8-8 of FIG. 4). In the free state, the inner tip of the tooth 148 protrudes inwardly past the diameter of the hole 130 and/or the torque fitting 132.

Referring to FIG. 9, when the cap nut 108 is coupled to the sleeve 104 by coupling the torque fitting 150 to the torque fitting 132, the distal portion of the spring 106 flexes outwardly so that the torque fitting 150 can slide past the inner tip of the tooth 148. The spring 106 has a fully flexed state when the outer surface of the jaw 146 contacts the inner surface of the shelf 142.

Referring to FIG. 10, when the cap nut 108 is fully coupled to the sleeve 104, the tooth 148 of the spring 106 is received in the groove 154 of the cap nut 108. The spring 106 has a partially flexed state when the tooth 148 is received in the groove 154, so that the tooth 148 is biased into the groove 154 with a light force sufficient to retain the cap nut 108 coupled to the sleeve 104 in use. The coupled torque fittings 132, 150 sustain substantially all of the torque loads in service. Advantageously, this reduces service loads on the spring 106 so that the spring can be small and inconspicuous.

While the illustrated instrument 100 has an internal torque fitting 132 in the sleeve 104, an external torque fitting 150 on the cap nut 108, and a spring 106 whose tooth 148 engages an exterior groove 154 of the cap nut 108, other arrangements are contemplated in which internal and external features are swapped.

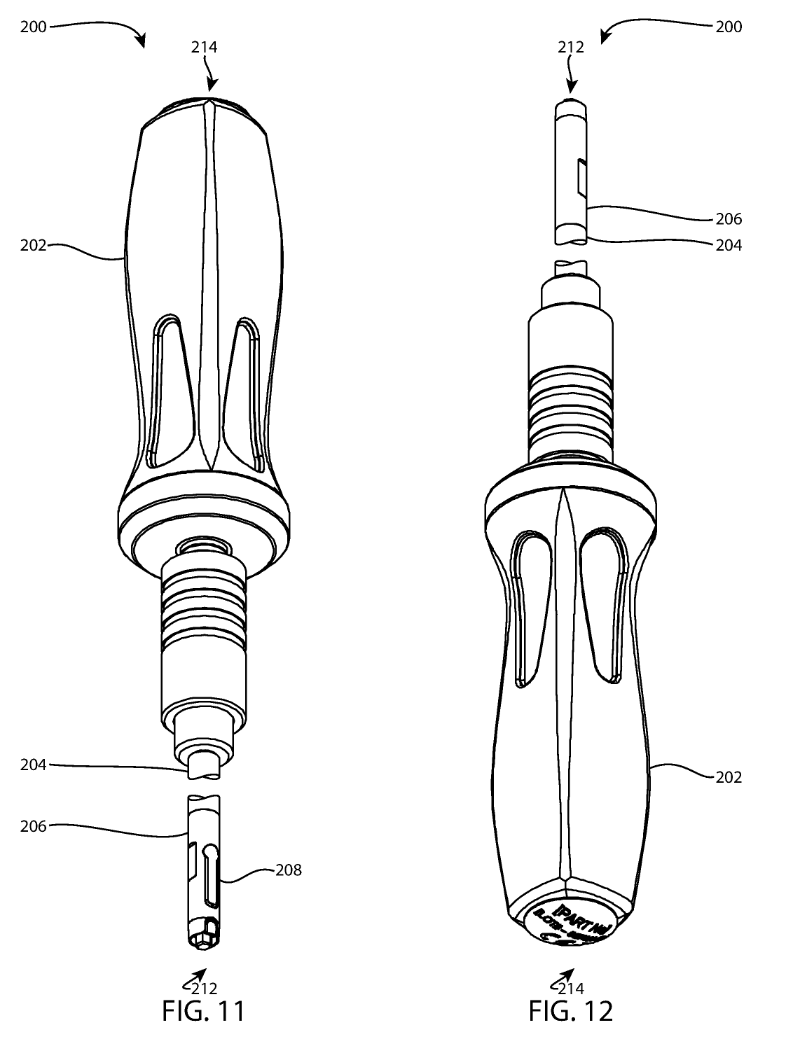

Referring to FIGS. 11-20, another instrument 200 may be an assembly that includes a handle 202, a shaft 204, a sleeve 206, and a spring 208. The instrument may couple to a screw 210 or other fastener, such as a nut. The instrument 200, its component parts 202, 204, 206, 208, and the screw 210 may each extend between a distal end 212, or working end, and a proximal end 214 toward a user.

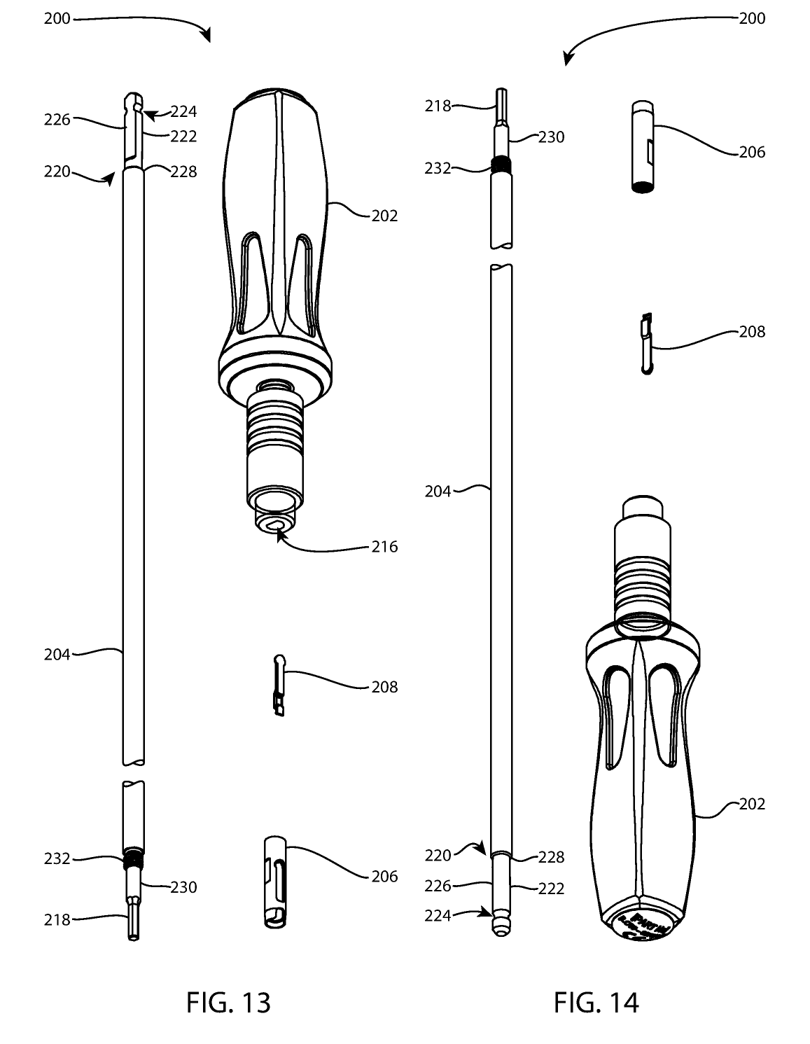

The handle 202 may be a subassembly of component parts. The handle 202 may include a distal torque fitting 216. A torque fitting 216 with a non-circular hole is shown in FIG. 13. The torque fitting 216 may connect to the torque fitting 116 of the shaft 102 of the instrument 100 to transmit torque to the shaft 102, or to the torque fitting 220 of the shaft 204 described below to transmit torque to the shaft 204.

The shaft 204 may be an elongated generally cylindrical part that may include a distal torque fitting 218 at the distal end 212 and a proximal torque fitting 220 at the proximal end 214. The distal torque fitting 218 may couple to the screw 210 described below to transmit torque to the screw 210. The distal torque fitting 218 may be a hex key as shown. The proximal torque fitting 220 may couple to the torque fitting 216 of the handle 202 to transmit torque to the shaft 204. The illustrated torque fitting 220 includes a proximal diameter portion 222, a groove 224, and a flat 226. The proximal diameter portion 222 may have a smaller outer diameter than the main portion of the shaft 204, as shown, a larger diameter, or the same nominal diameter and a different tolerancing scheme than the main portion of the shaft 204. A boundary 228 may exist between the proximal diameter portion 222 and the main portion of the shaft 204. The boundary 228 may be a shoulder formed due to a step change in diameter. The boundary 228 may be at the distal-most end of the torque fitting 220. The groove 224 may extend circumferentially around the proximal diameter portion 222 near the proximal end 214. The flat 226 may be unilateral and may extend longitudinally from the proximal end 214 to a location between the groove 224 and the boundary 228. The proximal torque fitting 220 may be identical to the torque fitting 116 of the shaft 102 of the instrument 100. Returning to the distal end 212, the shaft 204 may include a distal diameter portion 230 proximal to the distal torque fitting 218. The distal diameter portion 230 may have a smaller outer diameter than the main portion of the shaft 204, as shown, a larger diameter, or the same nominal diameter and a different tolerancing scheme than the main portion of the shaft 204. The shaft 204 may include an externally threaded portion 232 proximal to the distal diameter portion 230.

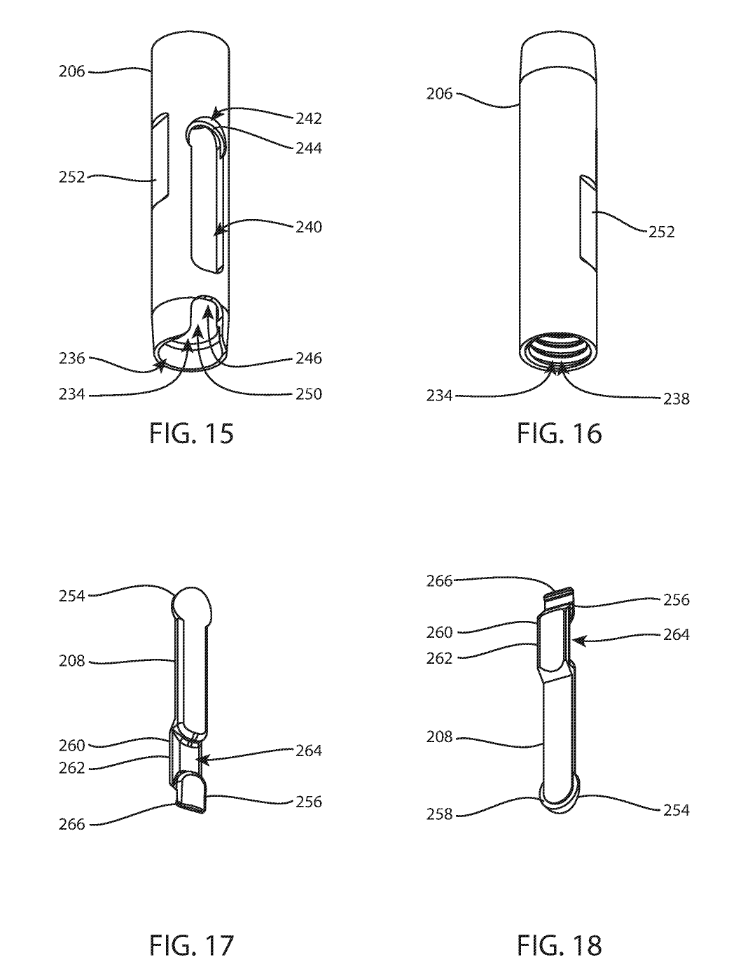

Referring to FIGS. 15 and 16, the sleeve 206 may be an elongated generally cylindrical part. A central longitudinal hole 234 may extend through the sleeve 206 between the distal and proximal ends 212, 214. A counterbore 236 may extend proximally into the distal end 212 of the sleeve 206. An internally threaded portion 238 may extend distally into the proximal end 214 of the sleeve 206. Between the counterbore 236 and the internally threaded portion 238, the hole 234 may have a uniform inner diameter. A window 240 may extend through one side of the sleeve 206 to intersect the hole 234. The illustrated window 240 intersects a middle portion of the hole 234. The window 240 may be longitudinally elongated such as the oval shown. A counterbore 242 may extend into an outer surface of the sleeve 206 around the proximal end of the window 240. The counterbore 242 may extend into the wall of the sleeve 206 to form a shelf 244. A longitudinal groove 246 may extend into an inner surface of the sleeve 206 adjacent to the distal end of the window 240, and may extend longitudinally distally from the window through the distal end 212. The groove 246 may be a longitudinal extension of the window 240. The groove 246 may extend partially through the wall of the sleeve 206 to form a shelf 248 (FIG. 20). A notch 250 may extend from the distal end 212 through one side of the sleeve 206 to intersect the groove 246 and hole 234, but may be spaced apart from the distal end of the window 240. Bilateral flats 252 may be formed in the outer surface of the sleeve 206 on either side of the window 240, and may extend longitudinally along the sleeve 206.

Referring to FIGS. 17 and 18, the spring 208 may be a thin narrow part that is elongated between the distal and proximal ends 212, 214. The spring 208 may have a generally rectangular cross-sectional shape. The spring 208 may include a proximal tab 254 and a distal jaw 256. The tab 254 may be wider than the rest of the spring 208. The tab 254 may be received in the counterbore 242 of the sleeve 206 so that an inner surface of the tab 254 directly contacts the shelf 244. The tab 254 may include a shelf 258 that directly contacts the shelf 244. The tab 254 may be permanently fixed in the counterbore 242, for example by welding. The jaw 256 may be distinguished from the rest of the spring 208 by an inwardly offset section 260 that forms an inner platform 262 and an opposite outer channel 264. When the tab 254 is received in the counterbore 242, the jaw 256 may be received in the notch 250 so that the channel 264 faces an inner surface of the shelf 248. The shelf 248 may limit outward flexion of the spring 208 so that the spring remains in the elastic zone and is prevented from experiencing yielding, plastic deformation, bending, cracking, or breaking. A tooth 266 may protrude from an inner surface of the jaw 256, and may extend transversely across the inner surface of the jaw 256 as shown.

Referring to FIG. 20, the screw 210 is a generally cylindrical part that extends between the distal and proximal ends 212, 214. The screw 210 may include a smooth distal tip portion 268 with a first outer diameter, an externally threaded portion 270 proximal to the tip portion 268 with a minor diameter and a major diameter, a smooth middle portion 272 proximal to the externally threaded portion 270 with a second outer diameter, and a head 274 proximal to the middle portion 272 with a third outer diameter. The head 274 may include a circumferential groove 276 near the proximal end 214, so that a flange 278 is formed around the proximal end 214. The flange 278 may have a fourth outer diameter. The head 274 may include a torque fitting 280, such as a hex socket, for coupling to the distal torque fitting 218 of the shaft 204.

When the instrument 200 is operatively assembled, the torque fitting 216 of the handle 202 may be coupled to the torque fitting 220 of the shaft 204 to transmit torque from the handle 202 to the shaft 204. The externally threaded portion 232 of the shaft 204 may be threaded into the internally threaded portion 238 of the sleeve 206 so that the torque fitting 218 is adjacent to the window 240, groove 246, shelf 248, and/or notch 250. The tab 254 of the spring 208 may be received in the counterbore 242 of the sleeve 206 so that the shelf 258 directly contacts the shelf 244, the jaw 256 is received in the notch 250, the channel 264 faces an inner surface of the shelf 248, and the tooth 266 faces into the hole 236 and/or counterbore 236. The tab 254 may be permanently fixed in the counterbore 242, for example by welding around the outer perimeter of the tab 254/inner perimeter of the counterbore 242.

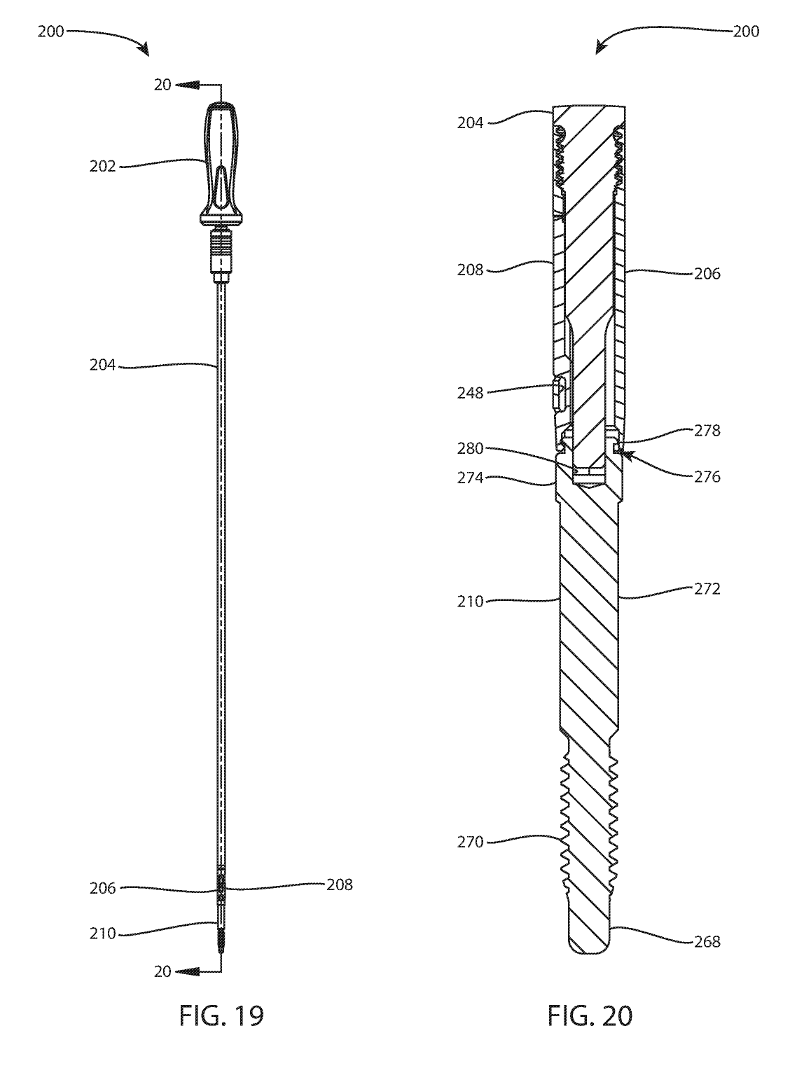

When the instrument 200 is operatively assembled, the spring 208 has a free state when the torque fitting 218 of the shaft 204 and the torque fitting 280 of the screw 210 are disconnected. As for instrument 100, in the free state, the inner tip of the tooth 266 is at its innermost position closest to the central longitudinal axis of the sleeve 206 (which is collinear with section line 20-20 of FIG. 19).

Referring to FIG. 20, when the screw 210 is coupled to the shaft 204 by coupling the torque fitting 218 to the torque fitting 280, the distal portion of the spring 208 flexes outwardly so that the flange 278 can slide past the inner tip of the tooth 266. The spring 208 has a fully flexed state when the outer surface of the channel 264 contacts the inner surface of the shelf 248. When the screw 210 is fully coupled to the shaft 204, sleeve 206, and spring 208, the tooth 266 of the spring is received in the groove 276 of the screw 210. The spring 208 has a partially flexed state when the tooth 266 is received in the groove 276, so that the tooth 266 is biased into the groove 276 with a light force sufficient to retain the screw 210 coupled to the shaft 204, sleeve 206, and spring 208 in use. The coupled torque fittings 218, 280 sustain substantially all of the torque loads in service. Advantageously, this reduces service loads on the spring 208 so that the spring can be small and inconspicuous.

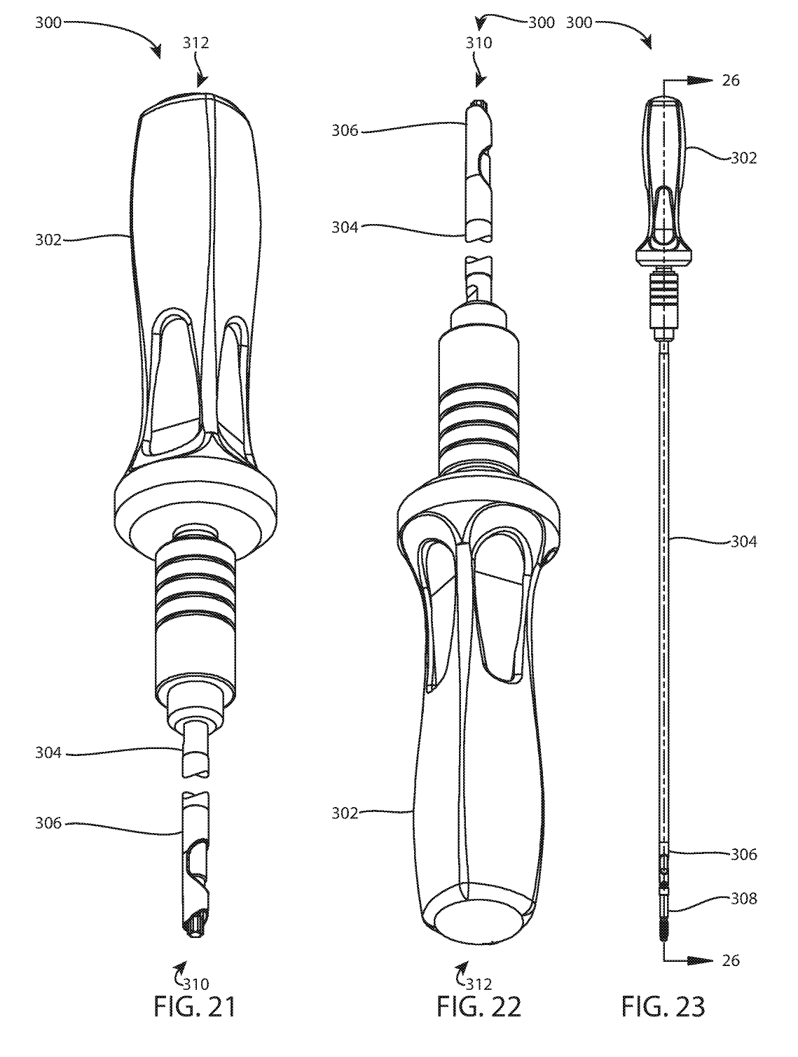

Referring to FIGS. 21-27, yet another instrument 300 may be an assembly that includes a handle 302, a shaft 304, and a sleeve 306. The instrument 300 may couple to a screw 308 or other fastener, such as a nut. The instrument 300, its component parts 302, 304, 306, and the screw 308 may each extend between a distal end 310, or working end, and a proximal end 312 toward a user.

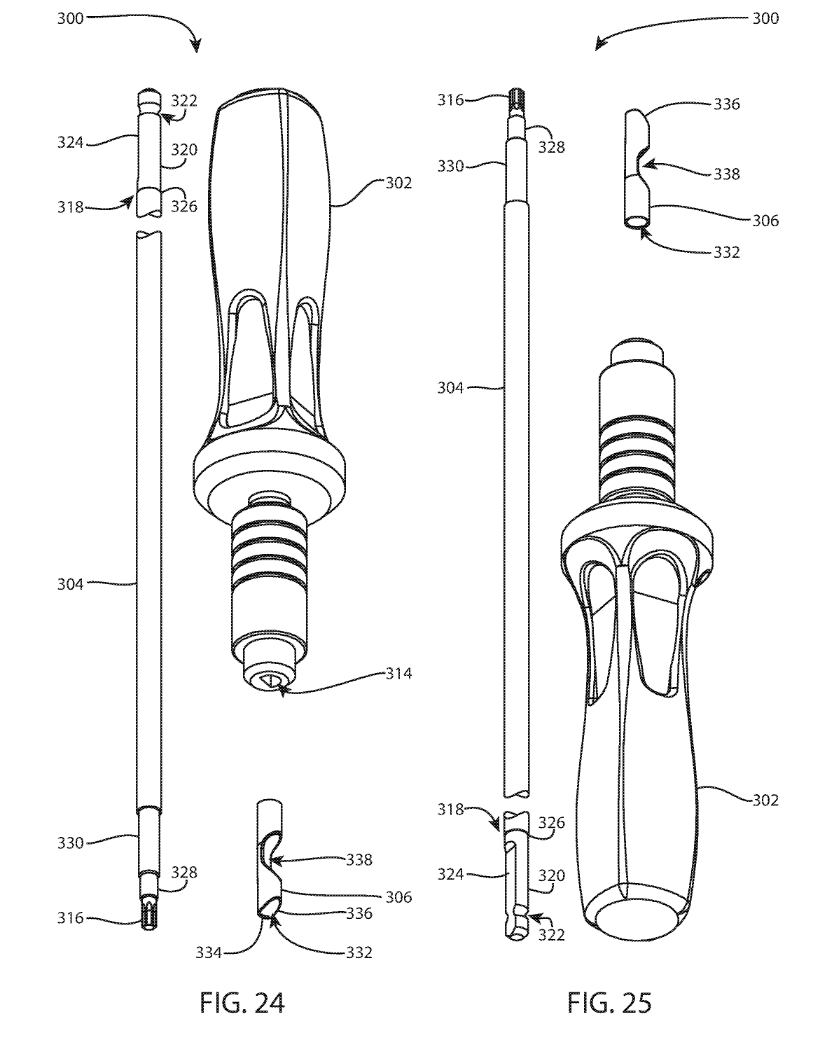

The handle 302 may be a subassembly of component parts. The handle 302 may include a distal torque fitting 314. A torque fitting 314 with a non-circular hole is shown in FIG. 24. The torque fitting 314 may connect to the torque fitting 116 of the shaft 102 of the instrument 100 to transmit torque to the shaft 102, or to the torque fitting 220 of the shaft 204 of the instrument 200 to transmit torque to the shaft 204, or to the torque fitting 318 of the shaft 304 described below to transmit torque to the shaft 304. The handle 302 may be identical to the handle 202 described above.

The shaft 304 may be an elongated generally cylindrical part that may include a distal torque fitting 316 at the distal end 310 and a proximal torque fitting 318 at the proximal end 312. The distal torque fitting 316 may couple to the screw 308 described below to transmit torque to the screw 308. The distal torque fitting 316 may be a hexalobular key as shown, a conventional hexagonal key, or another non-circular shape for torque transmission. The proximal torque fitting 318 may couple to the torque fitting 314 of the handle 302 or the torque fitting 216 of the handle 202 to transmit torque to the shaft 304. The illustrated torque fitting 318 includes a proximal diameter portion 320, a groove 322, and a flat 324. The proximal diameter portion 320 may have a smaller outer diameter than the main portion of the shaft 304, as shown, a larger diameter, or the same nominal diameter and a different tolerancing scheme than the main portion of the shaft 304. A boundary 326 may exist between the proximal diameter portion 320 and the main portion of the shaft 304. The boundary 326 may be a shoulder formed due to a step change in diameter. The boundary 326 may be at the distal-most end of the torque fitting 318. The groove 322 may extend circumferentially around the proximal diameter portion 320 near the proximal end 312. The flat 324 may be unilateral and may extend longitudinally from the proximal end 312 to a location between the groove 322 and the boundary 326. The proximal torque fitting 318 may be identical to the torque fitting 116 of the shaft 102 of the instrument 100 or the torque fitting 220 of the shaft 204 of the instrument 200. Returning to the distal end 310, the shaft 304 may include a first diameter portion 328 proximal to the distal torque fitting 316. The first diameter portion 328 may have a smaller outer diameter than the main portion of the shaft 304, as shown, a larger diameter, or the same nominal diameter and a different tolerancing scheme than the main portion of the shaft 304. The shaft 304 may include a second diameter portion 330 proximal to the first diameter portion 328. The second diameter portion 330 may have an outer diameter that is less than the main portion of the shaft 304 and greater than the first diameter portion 328.

The sleeve 306 may be an elongated generally cylindrical part. A central longitudinal hole 332 may extend through the sleeve 306 between the distal and proximal ends 310, 312. A tooth 334 may protrude from an inner surface of the hole 332 close to the distal end 310. The tooth 334 may extend circumferentially around a portion of the hole 332, which may be less than half of the circumference of hole 332 as shown. The sleeve 306 may include a distal beveled face 336 opposite the tooth 334. A window 338 or opening may extend through one side of the sleeve 306, on the same side as the beveled face 336 and opposite the tooth 334. The window 338 may be located in a middle portion of the distal to proximal length of the sleeve 306. The window 338 may notch out more than half of the circumference of the sleeve 306.

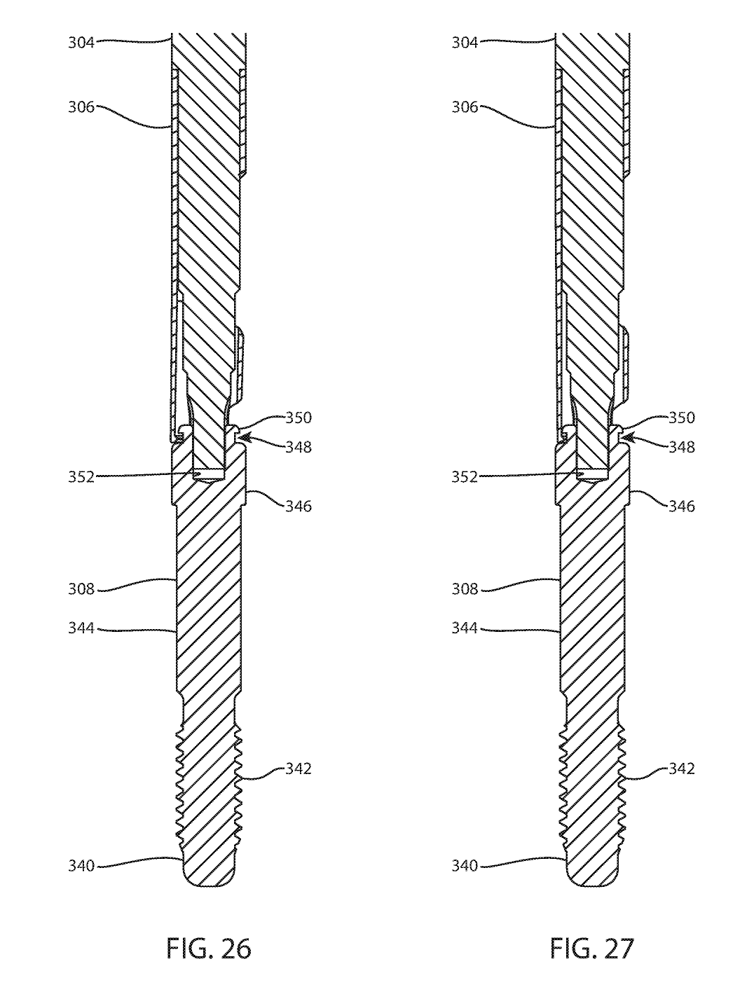

Referring to FIGS. 26-27, the screw 308 is a generally cylindrical part that extends between the distal and proximal ends 310, 312. The screw 308 may include a smooth distal tip portion 340 with a first outer diameter, an externally threaded portion 342 proximal to the tip portion 340 with a minor diameter and a major diameter, a smooth middle portion 344 proximal to the externally threaded portion 342 with a second outer diameter, and a head 346 proximal to the middle portion 344 with a third outer diameter. The head 346 may include a circumferential groove 348 near the proximal end 312 so that a flange 350 is formed around the proximal end 312 The flange 350 may have a fourth outer diameter. The head 346 may include a torque fitting 352 such as a hexalobular socket or conventional hexagonal socket, for coupling to the distal torque fitting 316 of the shaft 304.

When the instrument 300 is operatively assembled, the torque fitting 314 of the handle 302 may be coupled to the torque fitting 318 of the shaft 304 to transmit torque from the handle 302 to the shaft 304. The second diameter portion 330 of the shaft 304 may be received in the proximal end of the hole 332 of the sleeve 306 so that the torque fitting 316 is adjacent to the tooth 334 and/or beveled face 336. The shaft 304 and sleeve 306 may be permanently fixed together, for example by welding around the proximal end of the sleeve 306.

When the instrument 300 is operatively assembled, the sleeve 306 has a free state when the torque fitting 316 of the shaft 304 and the torque fitting 352 of the screw 308 are disconnected. As for instruments 100, 200, in the free state, the inner tip of the tooth 334 is at its innermost position closest to the central longitudinal axis of the sleeve 306 (which is collinear with section line 26-26 of FIG. 23).

Referring to FIGS. 26-27, when the screw 308 is coupled to the shaft 304 by coupling the torque fittings 316, 352 together, the distal portion of the sleeve 306 flexes outwardly so that the flange 350 can slide past the inner tip of the tooth 344. This is illustrated in FIG. 26. The sleeve 306 has a fully flexed state when the first diameter portion 328 contacts the inner surface of the hole 332. This contact may limit outward flexion of the sleeve 306 so that the sleeve remains in the elastic zone and is prevented from experiencing yielding, plastic deformation, bending, cracking, or breaking. When the screw 308 is fully coupled to the shaft 304 and sleeve 306, the tooth 334 of the sleeve is received in the groove 348 of the screw 308. The sleeve 306 has a partially flexed state when the tooth 334 is in the groove 348, so that the tooth 334 is biased into the groove 348 with a light force sufficient to retain the screw 308 coupled to the shaft 304 and sleeve 306 in use. This is illustrated in FIG. 27. The coupled torque fittings 316, 352 sustain substantially all of the torque loads in service. Advantageously, this reduces service loads on the sleeve 306.

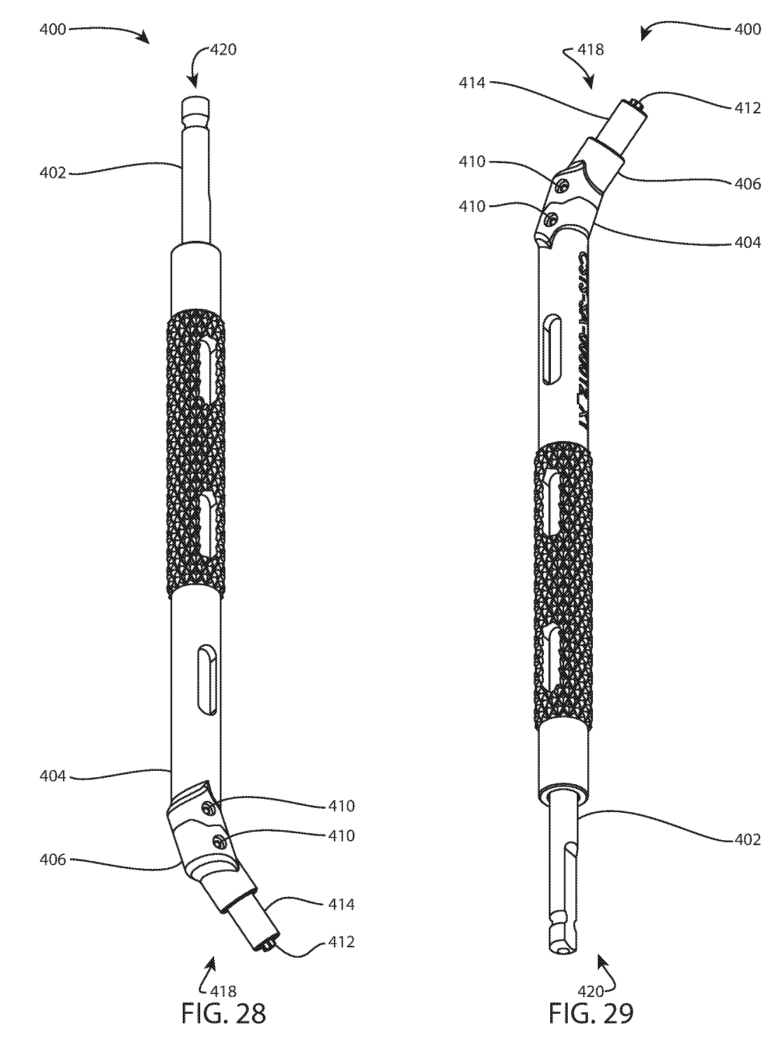

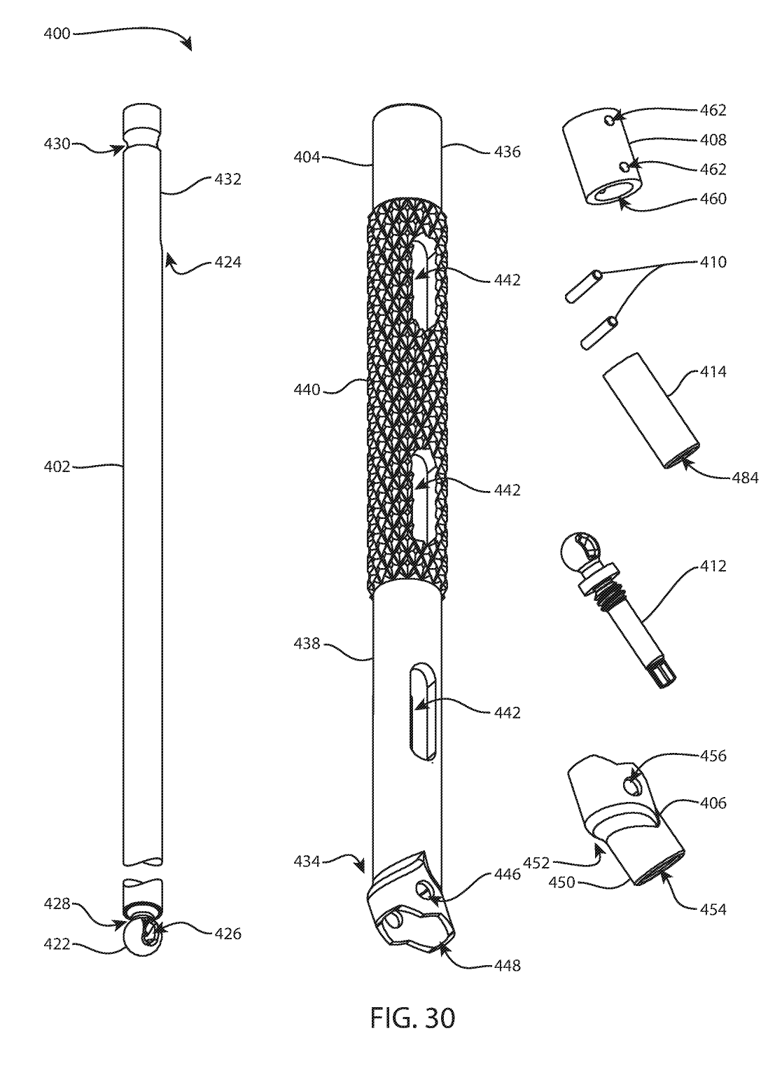

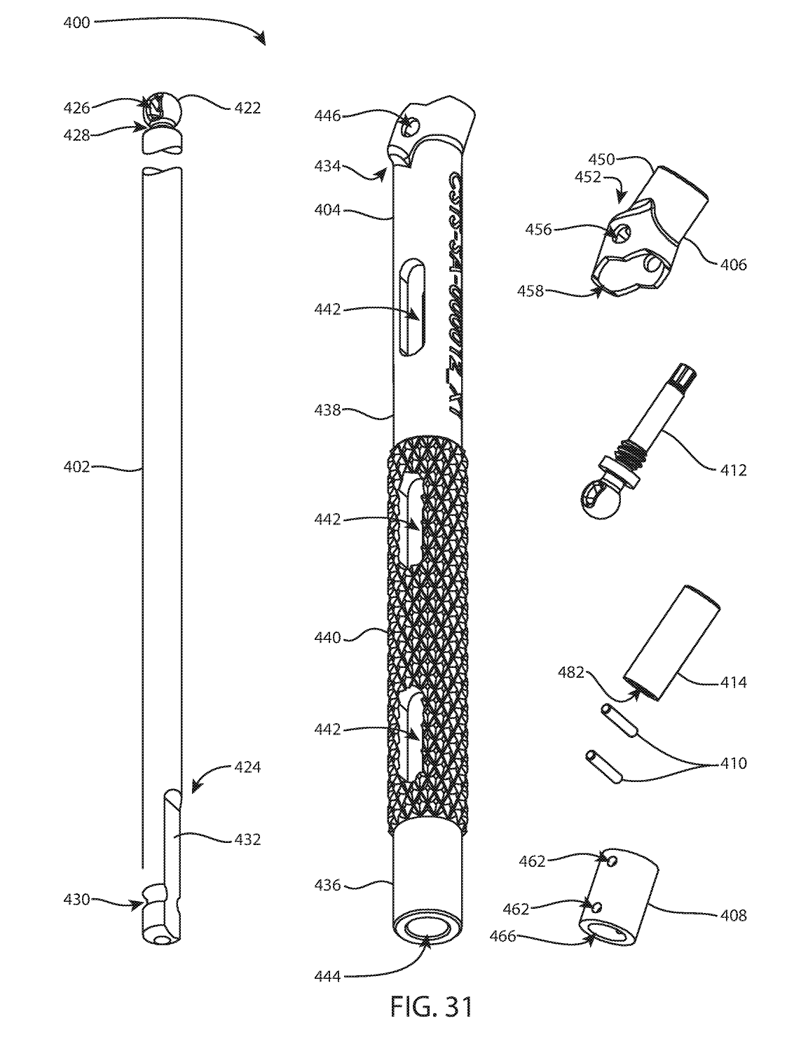

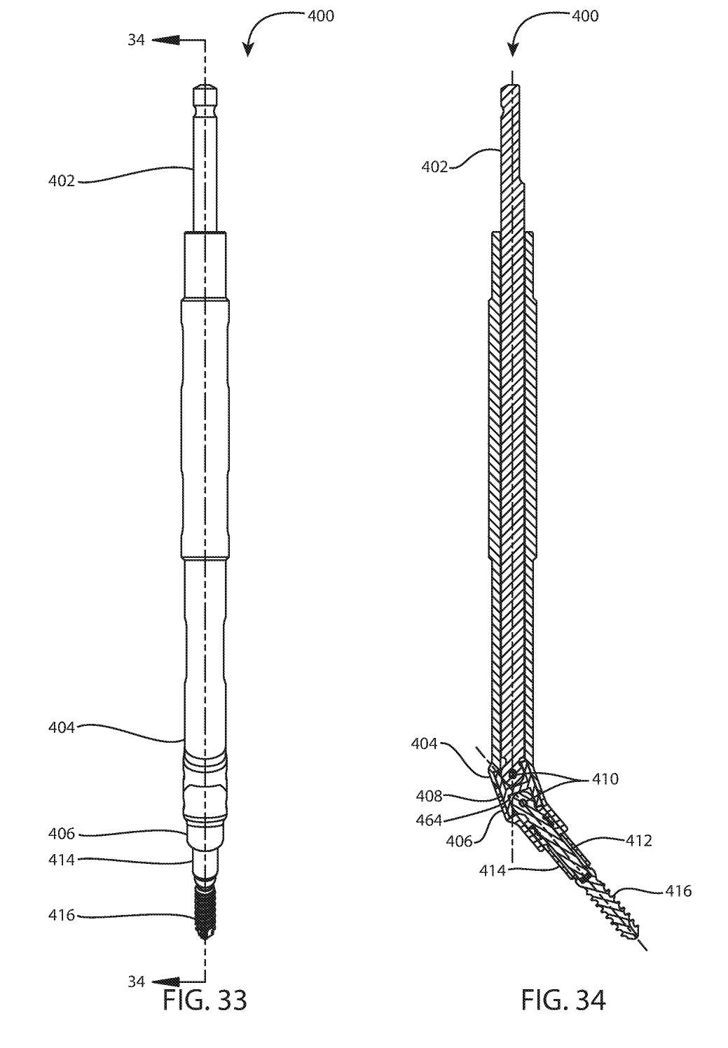

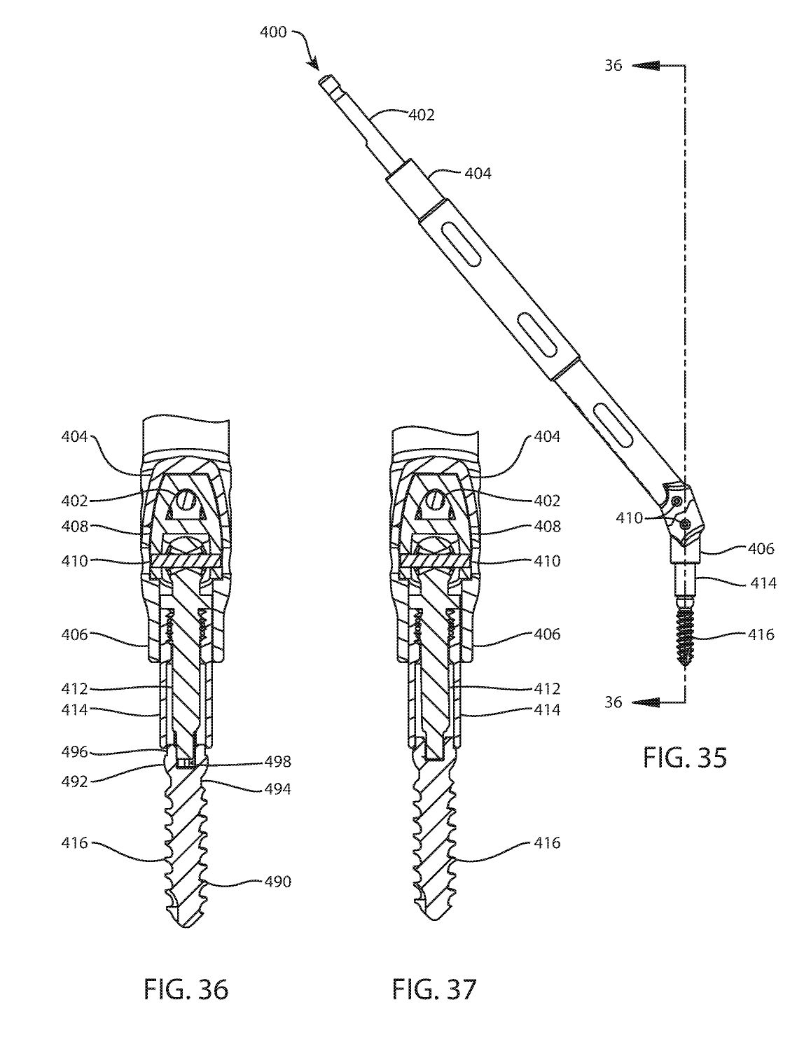

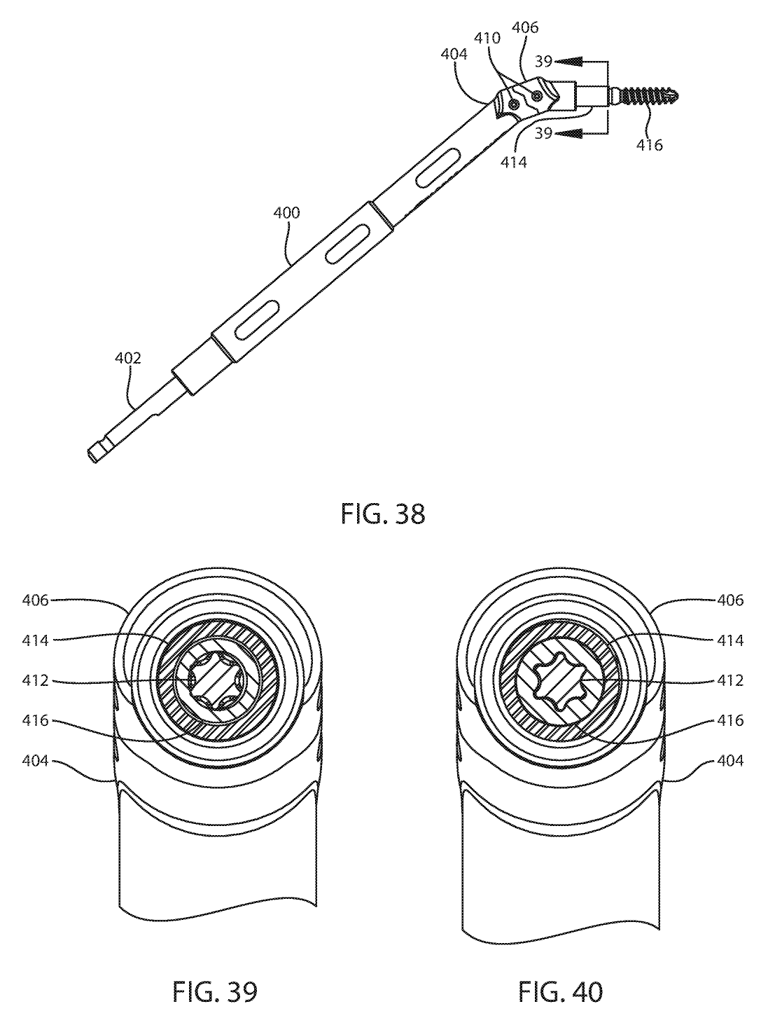

Referring to FIGS. 28-40, yet another instrument 400 may be an assembly that includes a shaft 402, a proximal housing 404, a distal housing 406, a ball housing 408, pins 410, a tip part 412, and a sleeve 414. The instrument 400 may couple to a screw 416 or other fastener, such as a nut. The instrument 400, its component parts 402, 404, 406, 408, 410, 412, 414, and the screw 416 may each extend between a distal end 418, or working end, and a proximal end 420 toward a user.

The shaft 402 may be an elongated generally cylindrical part that may include a distal ball 422, or head, and a proximal torque fitting 424. The ball 422 may couple to the ball housing 408 described below to transmit torque to the ball housing 408. The ball 422 may be a spherical feature with a transverse through hole 426. The hole 426 may be wider at each end where it exits the ball 422, and narrower near a spherical center of the ball 422. A narrow neck 428 may be present between the spherical ball 422 and the rest of the shaft 402. The proximal torque fitting 424 may couple to the torque fitting 216 of the handle 202 of the instrument 200 or the torque fitting 314 of the handle 302 of the instrument 300, or to another torque source. The illustrated torque fitting 424 includes a groove 430 and a flat 432. The groove 430 may extend circumferentially around the shaft 402 near the proximal end 420. The flat 432 may be unilateral and may extend longitudinally from the proximal end 420 to a location distal to the groove 430. The proximal torque fitting 424 may be identical to the torque fitting 116 of the shaft 102 of the instrument 100, the torque fitting 220 of the shaft 204 of the instrument 200, or the torque fitting 318 of the shaft 304 of the instrument 300.

The proximal housing 404 is an elongated generally cylindrical part with a short angled distal segment 434. The proximal main portion of the housing 404 may include proximal and distal smooth diameter sections 436, 438 separated by an intermediate knurled section 440. One or more windows 442 may extend transversely through the main portion of the housing 404. Three windows 442 are shown, two through the knurled section 440, and one through the distal smooth diameter section 438. The windows 442 may be longitudinal ovals as shown. A central longitudinal hole 444 may extend distally into the housing 404 from the proximal end 420 to the angled distal segment 434. The distal segment 434 may also be cylindrical. The distal segment 434 may intersect the main portion of the housing 404 at an acute angle. A nominal angle of 20° is shown, seen best in FIG. 34. The distal aspect of the distal segment 434 may have a sawtooth profile for registration against a proximal aspect of the distal housing 406. A transverse hole 446 may extend through the distal segment 434 near its intersection with the main portion of the housing 404. A central longitudinal hole 448 may extend proximally into the distal segment 434 from the distal end 418 to intersect the hole 444. The inner diameter of hole 448 may be greater than the inner diameter of hole 444.

The distal housing 406 may include a distal segment 450 and a short angled proximal segment 452. The distal segment 450 may be cylindrical with a central longitudinal hole 454 that extends proximally into the distal segment 450 from the distal end 418 to the angled proximal segment 452. The proximal segment 452 may also be cylindrical. The proximal segment 452 may intersect the distal segment 450 at an acute angle. A nominal angle of 20° is shown, seen best in FIG. 34. The proximal aspect of the proximal segment 452 may have a sawtooth profile for registration against the distal aspect of the distal segment 434 of the proximal housing 404. A transverse hole 456 may extend through the proximal segment 452 near its intersection with the distal segment 450. A central longitudinal hole 458 may extend distally into the proximal segment 452 from the proximal end 420 to intersect the hole 454. The inner diameter of hole 458 may be greater than the inner diameter of hole 454.

The ball housing 408 is a cylindrical part with a central longitudinal hole 460 and a transverse hole 462. Two parallel transverse holes 462 are shown, spaced apart longitudinally. The hole 460 extends into the ball housing 408 and terminates at a transverse wall 464 (FIG. 34). Another central longitudinal hole 466 extends into the ball housing 408 opposite the hole 460, and terminates at the opposite side of the wall 464. Alternatively, the wall 464 and hole 466 may be omitted, and the hole 460 may extend through the ball housing 408. The ends of the ball housing 408 are received in the hole 448 of the proximal housing 404 and the hole 458 of the distal housing 406. The ball 422 of the shaft 402 is received in the hole 466 of the ball housing 408 and retained by a pin 410 through the holes 462, 426.

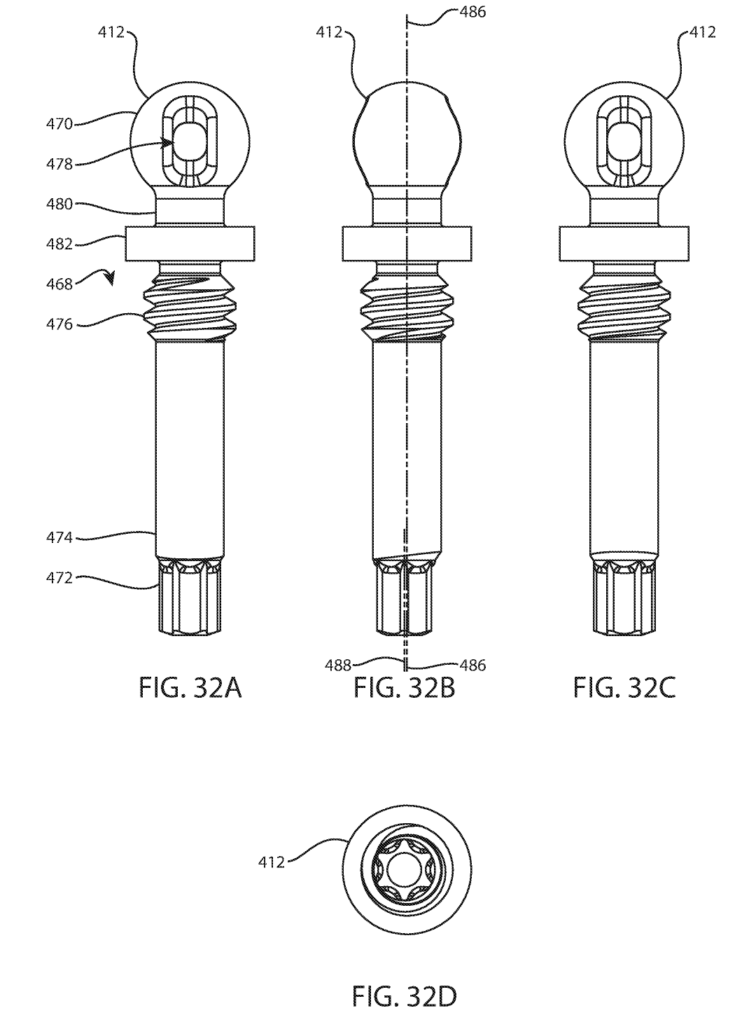

Referring to FIGS. 32A-32D, the tip part 412 includes a distal shaft 468 and a proximal ball 470, or head. The shaft 468 includes a distal torque fitting 472, an intermediate smooth shank 474 proximal to the torque fitting 472, and an externally threaded portion 476 proximal to the shank. The torque fitting 472 may be a hexalobular key as shown, a conventional hexagonal key, or another non-circular shape for torque transmission to the screw 416. The ball 470 may be a spherical feature with a transverse through hole 478. The hole 478 may be wider at each end where it exits the ball 470, and narrower near a spherical center of the ball 470. A narrow neck 480 may be present between the spherical ball 470 and the shaft 468. A circumferential flange 482 may be present between the neck 480 and the externally threaded portion 476. Advantageously, in this example the torque fitting 472 is eccentrically positioned relative to the rest of the tip part 412 (FIGS. 32B and 32D). In other words, the central longitudinal axis 486 of the shank 474, externally threaded portion 476, flange 482, neck 480, and/or ball 470 and the central longitudinal axis 488 of the torque fitting 472 are not collinear, although they may be parallel. The nominal distance between axes 486, 488 in FIG. 32B is 0.004 in. The ball 470 may couple to the ball housing 408 to transmit torque from the ball housing 408 to the tip part 412. The ball 470 is received in the hole 460 of the ball housing and retained by a pin 410 through the holes 462, 478. The flange 482 may be received in the hole 454 of the distal housing 406.

The sleeve 414 is a cylindrical part with a proximal internally threaded portion 482 that threads onto the externally threaded portion 476 of the tip part 412. The minor diameter of the internal threads continues distally through the sleeve 414, and is sized to receive the shank 474 of the tip part 412. A central longitudinal hole 484 extends proximally into the distal end 418 and terminates in a middle portion of the sleeve 414. The inner diameter of the hole 484 is greater than the minor diameter of the internally threaded portion 482 so that when the tip part 412 and the sleeve 414 are assembled, there is clearance around the distal portion of the tip part 412. The proximal end of the sleeve 414 may be received in the hole 454 of the distal housing 406.

Referring to FIGS. 36 and 37, the screw 416 is a generally cylindrical part that extends between the distal and proximal ends 418, 420. The screw 416 may include an externally threaded shaft 490 and a spherical head 492. A narrow neck 494 may connect the shaft 490 to the head 492. The head 492 may include a proximal cylindrical portion 496. The head 492 may include a torque fitting 498 such as a hexalobular socket or conventional hexagonal socket, for coupling to the torque fitting 472 of the tip part 412.

When the instrument 400 is operatively assembled, the ball 422 of the shaft 402 is received in the hole 466 of the ball housing 408 and retained by a pin 410 through the holes 462, 426. The ball 470 of the tip part 412 is received in the hole 460 of the ball housing 408 and retained by a pin 410 through the holes 462, 478. The internally threaded portion 482 of the sleeve 414 threads onto the externally threaded portion 476 of the tip part 412. The proximal end of the ball housing 408 is received in the hole 448 of the proximal housing 404 and the shaft 402 is received in the hole 444 of the housing 404. The distal end of the ball housing 408 is received in the hole 458 of the distal housing 406 and the flange 482 of the tip part 412 and the proximal portion of the sleeve 414 are received in the hole 454 of the housing 406. The distal aspect of the housing 404 abuts the proximal aspect of the housing 406. The housings 404, 406 may be permanently fixed together, for example by welding along the interface between the distal and proximal aspects.

When the instrument 400 is operatively assembled, the shaft 402, ball housing 408, tip part 412, and pins 410 form a fixed angle torque transmission linkage to transmit torque from a handle or other torque source into the torque fitting 424 of the shaft and through the torque fitting 472 of the tip part 412 to the screw 416.

When the instrument 400 is operatively assembled, the tip part 412 has a free state when the torque fitting 472 of the tip part 412 and the torque fitting 498 of the screw 416 are disconnected. The free state is illustrated in FIGS. 32A-32D. The tip part 412 extends straight along the axis 486 with the eccentric torque fitting 472 at the distal end.

Referring to FIGS. 36 and 39, as the screw 416 is coupled to the tip part 412, first the torque fittings 472, 498 start to engage, then the cylindrical portion 496 of the screw 416 starts to enter the hole 484 of the sleeve 414. This forces the tip part 412 to flex laterally within the hole 484 to move the torque fitting 472 toward the center of the hole 484. The sleeve 414 may also flex laterally opposite to the tip part 412. In various embodiments, the tip part 412 or the sleeve 414 may be the only part to flex, or both parts may flex.

Referring to FIGS. 37 and 40, as the screw 416 and tip part 412 become fully engaged, the tip part 412 is in a fully flexed state with the torque fitting 472 near the center of the hole 484 (within part tolerances). The cylindrical portion 496 of the screw 416 is gripped between the inner wall of the hole 484 of the sleeve 414 and the torque fitting 472 of the tip part 412 with a light force sufficient to retain the screw 416 coupled to the tip part 412 and shaft 414 in use. Flexion of the tip part 412 may be limited so that the tip part remains in the elastic zone and is prevented from experiencing yielding, plastic deformation, bending, cracking, or breaking. The coupled torque fittings 472, 498 sustain substantially all of the torque loads in service.

Any methods disclosed herein includes one or more steps or actions for performing the described method. The method steps and/or actions may be interchanged with one another. In other words, unless a specific order of steps or actions is required for proper operation of the embodiment, the order and/or use of specific steps and/or actions may be modified.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, Figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. § 112 Para. 6. It will be apparent to those having skill in the art that changes may be made to the details of the above-described embodiments without departing from the underlying principles of the technology.

While specific embodiments and applications of the present technology have been illustrated and described, it is to be understood that the technology is not limited to the precise configuration and components disclosed herein. Various modifications, changes, and variations which will be apparent to those skilled in the art may be made in the arrangement, operation, and details of the methods and systems of the present technology disclosed herein without departing from the spirit and scope of the technology.

1. A system comprising:
a fastener comprising a head comprising a fastener torque fitting; and
a tool comprising a tool torque fitting and a spring, wherein the tool torque fitting engages the fastener torque fitting to transmit torque between the tool and the fastener;
wherein when the tool torque fitting is engaged with the fastener torque fitting, the spring presses upon the fastener head to retain the fastener to the tool;
wherein the tool limits flexion of the spring so that the spring functions only in its elastic zone.

2. The system of claim 1, wherein the spring comprises a free state and a fully flexed state;
wherein the spring is in the free state when the tool is disengaged from the fastener;
wherein when the spring is in the fully flexed state, a tool-contacting portion of the spring contacts a spring-contacting portion of the tool to limit further flexion of the spring, and the spring is in its elastic zone.

3. The system of claim 2, wherein the spring moves from the free state toward the fully flexed state as the tool torque fitting engages the fastener torque fitting.

4. The system of claim 2, wherein the tool comprises a tool axis;
wherein the tool torque fitting engages the fastener torque fitting to transmit torque between the tool and the fastener about the tool axis;
wherein when the spring is in the free state, a fastener-contacting portion of the spring is a first distance from the tool axis;
wherein when the spring is in the fully flexed state, the fastener-contacting portion of the spring is a second distance from the tool axis, wherein the second distance is different from the first distance.

5. The system of claim 4, wherein the tool comprises a shaft that comprises the tool torque fitting;
wherein the spring is a tube comprising a central longitudinal through hole;
wherein the shaft extends through the through hole;
wherein the tool-contacting portion of the spring is an inner surface of the through hole;
wherein the spring-contacting portion of the tool is an outer surface of the shaft.

6. The system of claim 5, wherein the spring comprises an opening through one side wall of the tube between the through hole and an exterior surface of the tube.

7. The system of claim 5, wherein the fastener-contacting portion of the spring is a tooth that protrudes from the inner surface of the through hole;
wherein the fastener head comprises a circumferential groove;
wherein when the tool torque fitting is engaged with the fastener torque fitting, the tooth is received in the groove to retain the fastener to the tool.

8. A system comprising:
a fastener comprising a head comprising a fastener coupling; and
a tool comprising a tool coupling and a spring, wherein the tool coupling engages the fastener coupling to actuate the fastener;
wherein when the tool coupling is engaged with the fastener coupling, the spring presses upon the fastener head to retain the fastener to the tool;
wherein the tool limits flexion of the spring so that the spring functions only in its elastic zone.

9. The system of claim 8, wherein the spring comprises a free state and a fully flexed state;
wherein the spring is in the free state when the tool is disengaged from the fastener;
wherein when the spring is in the fully flexed state, a tool-contacting portion of the spring contacts a spring-contacting portion of the tool to limit further flexion of the spring, and the spring is in its elastic zone.

10. The system of claim 9, wherein the spring moves from the free state toward the fully flexed state as the tool coupling engages the fastener coupling.

11. The system of claim 9, wherein the tool comprises a central longitudinal tool axis;
wherein when the spring is in the free state, a fastener-contacting portion of the spring is a first distance from the tool axis;
wherein when the spring is in the fully flexed state, the fastener-contacting portion of the spring is a second distance from the tool axis, wherein the second distance is different from the first distance.

12. The system of claim 11, wherein the tool comprises a shaft that comprises the tool coupling;
wherein the spring is a tube comprising a central longitudinal through hole;
wherein the shaft extends through the through hole;
wherein the tool-contacting portion of the spring is an inner surface of the through hole;
wherein the spring-contacting portion of the tool is an outer surface of the shaft.

13. The system of claim 12, wherein the spring comprises an opening through one side wall of the tube between the through hole and an exterior surface of the tube.

14. The system of claim 12, wherein the fastener-contacting portion of the spring is a tooth that protrudes from the inner surface of the through hole;
wherein the fastener head comprises a circumferential groove;
wherein when the tool coupling is engaged with the fastener coupling, the tooth is received in the groove to retain the fastener to the tool.

15. A system comprising:
a fastener comprising a head comprising a fastener coupling; and
a tool comprising a tool coupling and a sleeve around the tool coupling, wherein the tool coupling engages the fastener coupling to actuate the fastener;
wherein when the tool coupling is engaged with the fastener coupling, the sleeve presses upon the fastener head to retain the fastener to the tool;
wherein the tool limits flexion of the sleeve so that the sleeve is prevented from experiencing yielding, plastic deformation, or bending.

16. The system of claim 15, wherein the sleeve comprises a free state and a fully flexed state;
wherein the sleeve is in the free state when the tool is disengaged from the fastener;
wherein when the sleeve is in the fully flexed state, a tool-contacting portion of the sleeve contacts a sleeve-contacting portion of the tool to limit further flexion of the sleeve to prevent the sleeve from experiencing yielding, plastic deformation, or bending.

17. The system of claim 16, wherein the sleeve moves from the free state toward the fully flexed state as the tool coupling engages the fastener coupling.

18. The system of claim 16, wherein the tool comprises a central longitudinal tool axis;
wherein when the sleeve is in the free state, a fastener-contacting portion of the sleeve is a first distance from the tool axis;
wherein when the sleeve is in the fully flexed state, the fastener-contacting portion of the sleeve is a second distance from the tool axis, wherein the second distance is different from the first distance.

19. The system of claim 18, wherein the tool comprises a shaft that comprises the tool coupling;
wherein the sleeve is a tube comprising a central longitudinal through hole;
wherein the shaft extends through the through hole;
wherein the tool-contacting portion of the sleeve is an inner surface of the through hole;
wherein the sleeve-contacting portion of the tool is an outer surface of the shaft.

20. The system of claim 19, wherein the fastener-contacting portion of the sleeve is a tooth that protrudes from the inner surface of the through hole;
wherein the fastener head comprises a circumferential groove;
wherein when the tool coupling is engaged with the fastener coupling, the tooth is received in the groove to retain the fastener to the tool.
